(19) United States
(12) Patent Application Publication
(10) Pub. No.: US 2005/0064205 A1
(43) Pub. Date: Mar. 24, 2005

(54) Glass article

(75) Inventors: Masahiro Sawada, Shiga (JP); Toshimasa Kanai, Shiga (JP); Tsutomu Imamura, Shiga (JP); Ukon Ishihara, Shiga (JP)

Correspondence Address: NIXON & VANDERHYE, PC, 1100 N GLEBE ROAD, 8TH FLOOR, ARLINGTON, VA, 22201-4714, US

(73) Assignee: Nippon Electric Glass Co., Ltd., Shiga (JP)

(21) Appl. No.: 10/947,422

(22) Filed: Sep. 23, 2004

(30) Foreign Application Priority Data
Sep. 24, 2003 (JP) P. 2003-331037
Aug. 10, 2004 (JP) P. 2004-233820

(51) Int. Cl. B32B 17/06

(52) U.S. Cl. 428/432; 428/701; 428/702; 428/469

(57) ABSTRACT

A glass article which comprises a transparent heat-resistant glass sheet and a light-shielding layer on the surface thereof, wherein an average visible light transmittance at a wavelength of 380-780 nm of the glass article is 0.03-15%; and an average infrared reflectance at a wavelength of 1000-2500 nm of the glass article is at least 50%.

### FIELD OF THE INVENTION

The present invention relates to a glass article to be used for observation windows of high-temperature furnaces such as garbage incinerators, cremation furnaces, metal fusing furnaces, glass fusing furnaces and heat-treating furnaces, through which the inside condition of the furnaces is observed.

### BACKGROUND OF THE INVENTION

Heretofore, observation windows are installed in high-temperature instruments such as stoves, so as to observe the inside condition of the instruments through them. In such the observation windows, transparent heat-resistant glass that is hardly broken by thermal shock even when exposed to high temperatures is used, for example, low-expansion crystallized glass (e.g., see Patent Documents 1 and 2), high silicate glass, borosilicate glass, quartz glass, etc.
[Patent Document 1] JP-A 4-214046
[Patent Document 2] JP-A 2000-247681

### SUMMARY OF THE INVENTION

However, when the crystallized glass for observation windows of stoves, disclosed in Patent Documents 1 and 2, is used as the material for observation windows that are exposed to higher temperature than stoves, such as garbage incinerators, metal fusing furnaces, glass fusing furnaces and heat-treating furnaces, then it could not almost block out visible light and heat rays. Therefore, if operators try to observe the inside condition of the furnaces through the observation windows without protectors such as light-shielding glasses or light-shielding plates, then they may be dazzled and hot. Another problem with them is that the heat in the furnaces goes out through the observation windows. Therefore, the thermal efficiency of the furnaces is poor.

If protectors such as light-shielding glasses or light-shielding plates are used when the inside condition of the furnaces is observed through the observation windows, then they may be effective for dazzling prevention but are not effective for heat insulation. In addition, using the light-shielding plates worsens the operators' working efficiency. These are still other problems with the observation windows of the type.

### SUMMARY OF THE INVENTION

An object of the invention is to provide a glass article that exhibits excellent anti-dazzling and heat-insulating effects when used for observation windows of high-temperature furnaces such as glass fusing furnaces, and therefore enables long-time observation of the inside of furnaces through the observation windows without protectors, and does not detract from the thermal efficiency of the furnaces.

We, the present inventors have found that, when a visible light-shielding layer having the ability to block out light and the ability to reflect heat rays is formed on the surface of transparent heat-resistant glass, and when the coated glass is used for observation windows of furnaces, then it prevents the transmission of visible light and heat rays through the observation windows and retards radiation heat through them. Therefore, the observation windows prevent from dazzle and hotness, and enable long-time observation of the inside of furnaces through them without protectors, and do not detract from the heat efficiency of furnaces. On the basis of these findings, we have proposed the present invention.

Specifically, the invention has the following constitution.

(1) A glass article which comprises a transparent heat-resistant glass sheet and a visible light-shielding layer on the surface thereof,
wherein an average visible light transmittance of the glass article at a wavelength of 380-780 nm is 0.03-15%; and
an average infrared reflectance of the glass article at a wavelength of 1000-2500 nm is at least 50%.

(2) The glass article according to the above (1), wherein an average infrared transmittance of the glass article at a wavelength of 1000-2500 nm is 10% or less.

(3) The glass article according to the above (1), wherein an average thermal expansion coefficient at 30-380° C. of the transparent heat-resistant glass sheet is −20-+50×10⁻⁷/° C.

(4) The glass article according to the above (3), wherein the transparent heat-resistant glass sheet is any of transparent crystallized glass, high silicate glass, borosilicate glass or quartz glass.

(5) The glass article according to the above (1), wherein the visible light-shielding layer comprises a visible light-shielding film and optionally a heat ray reflection film.

(6) The glass article according to the above (1), wherein the visible light-shielding layer comprises a visible light-shielding film selected from the following (a)-(d):
(a) one metal selected from the group consisting of Ti, Nb, Ag, Pt, Au, Zr, Hf, Ni and Cr;
(b) one metal nitride with a metal selected from the group consisting of Ti, Nb, Ag, Zr, Hf, Ni and Cr;
(c) one alloy selected from the group consisting of TiAl, NiCr, stainless and hastelloy;
(d) one alloy nitride with an alloy selected from the group consisting of TiAl, NiCr, stainless and hastelloy.

(7) The glass article according to the above (1), wherein the visible light-shielding layer comprises a visible light-shielding film selected from the following (a)-(e) and a heat ray reflection film of the following (f):
(a) one metal selected from the group consisting of Ti, Nb, Ag, Pt, Au, Zr, Hf, Ni and Cr;
(b) one metal nitride with a metal selected from the group consisting of Ti, Nb, Ag, Zr, Hf, Ni and Cr;
(c) one alloy selected from the group consisting of TiAl, NiCr, stainless and hastelloy;
(d) one alloy nitride with an alloy selected from the group consisting of TiAl, NiCr, stainless and hastelloy;
(e) Si;
(f) one oxide selected from the group consisting of tin-doped indium oxide, fluorine-doped tin oxide, antimony-doped tin oxide, and aluminium-doped zinc oxide.

(8) The glass article according to the above (5), which has at least a protective film adjacent to the visible light-shielding film or the heat ray reflection film thereof.

(9) The glass article according to the above (8), wherein the protective film comprises at least one selected from the group consisting of SiO₂, Si₃N₄, AlN, SiAlNₓ and TiO₂.

(10) The glass article according to the above (1), which has at least an adhesive layer.

(11) The glass article according to the above (8), wherein the heat-resistant glass sheet comprises, on the surface thereof, the visible light-shielding film and the protective film, in this order.

(12) The glass article according to the above (8), wherein the heat-resistant glass sheet comprises, on the surface thereof, the heat ray reflection film, the protective film, and the visible light-shielding film, in this order.

(13) The glass article according to the above (8), wherein the heat-resistant glass sheet comprises, on the surface thereof, the heat ray reflection film, the protective film, the visible light-shielding film, and the protective film, in this order.

(14) The glass article according to the above (8), wherein the heat-resistant glass sheet comprises, on the surface thereof, the heat ray reflection film, the adhesive film, the protective film, the visible light-shielding film, and the protective film, in this order.

(15) The glass article according to the above (8), wherein the heat-resistant glass sheet comprises, on the surface thereof, the visible light-shielding film and the protective film, in this order; and on the opposite surface thereof, the heat ray reflection film and the protective film, in this order.

The glass article of the invention has a visible light-shielding layer formed on the surface of a transparent heat-resistant glass sheet, and an average visible light transmittance of the glass article at a wavelength of 380-780 nm is 0.03-15% (this corresponds to a scale number of 3-9 in JIS T-8141). Accordingly, when the glass article is used for observation windows of high-temperature furnaces, then operators can sufficiently observe the inside of the furnaces through them, not being dazzled even though they do not use protectors.

If the average visible light transmittance of the glass article at a wavelength of 380-780 nm is lower than 0.03%, then the inside of furnaces could not be sufficiently observed because the glass article could not transmit enough visible light through it; but if larger than 15%, then the glass article may transmit too much visible light through it. Therefore, operators feel dazzling, and, if so, it will be impossible to observe the inside of the furnaces without use of protectors.

Preferably, the average visible light transmittance of the glass article at a wavelength of 380-780 nm is 0.05-10%, more preferably 0.1-8%.

In addition, the average infrared (hereinafter, simply referred to as “IR”) reflectance of the glass article at a wavelength of 1000-2500 nm is at least 50%. Therefore, even when the inside of the furnaces is observed for a long period of time through the observation windows formed of the glass article without using protectors, the heat ray transmittance through the observation windows is low and the radiation heat from the observation windows is retarded. Therefore, operators do not feel hot.

In addition, even when the area of the observation window is broadened, the heat loss through it is small. Therefore, the thermal efficiency of the furnaces is not lowered. If so, in addition, an additional electronic appliance such as a video camera may be installed at around the observation window, and the inside of furnaces could be observed in a control room.

Preferably, the average IR reflectance of the glass article at a wavelength of 1000-2500 nm is at least 55%, more preferably at least 60%.

### DETAILED DESCRIPTION OF THE INVENTION

When the average IR transmittance of the glass article of the invention at a wavelength of 1000-2500 nm is 10% or less, then the amount of the heat rays that can pass through the observation windows formed of the glass article is small and therefore, the inside of furnaces can be readily observed through the observation windows even when no protectors are used.

This is because of the following reasons: When the amount of the heat rays that may pass through the glass article is smaller, then the total of the heat rays that are reflected by the glass article and absorbed by it is larger. The heat rays absorbed by the glass article can be radiated as radiation heat, but the radiation heat goes out from both surfaces of the glass article. Therefore, the quantity of heat that is radiated toward the observers from the inside of the furnaces through the glass article is the total of the transmitted heat rays and the radiation heat, and this may be relatively reduced.

Preferably, the average IR transmittance at a wavelength of 1000-2500 nm is 8% or less, more preferably at most 7% or less.

Also preferably, as the transparent heat-resistant glass sheet for the glass article of the invention has an average thermal expansion coefficient at 30-380° C. of −20-+50×10⁻⁷/° C., it is hardly broken by thermal shock. The transparent heat-resistant glass that has such an average thermal expansion coefficient falling within the range includes transparent crystallized glass such as typically LiO₂—Al₂O₃—SiO₂ crystallized glass that comprises a β-quartz solid solution as the main crystal thereof; and low-expansion glass such as typically high silicate glass, borosilicate glass or quartz glass. In addition, high silicate glass contains SiO₂ more than 96 weight % like bycor® (manufactured by Corning Inc.).

In particular, the transparent LiO₂—Al₂O₃—SiO₂ crystallized glass that comprises a β-quartz solid solution as the main crystal thereof has an average thermal expansion coefficient at 30-380° C. of −20-+20×10⁻⁷/° C. and is favorable, since it hardly softens and deforms even at high temperatures.

Preferably, the visible light-shielding layer of the glass article of the invention comprises one visible light-shielding film selected from the following (a)-(d):

(a) one metal selected from the group consisting of Ti, Nb, Ag, Pt, Au, Zr, Hf, Ni and Cr;
(b) one metal nitride with a metal selected from the group consisting of Ti, Nb, Ag, Zr, Hf, Ni and Cr;
(c) one alloy selected from the group consisting of TiAl, NiCr, stainless and hastelloy;
(d) one alloy nitride with an alloy selected from the group consisting of TiAl, NiCr, stainless and hastelloy.

The glass article of the type is preferred as its ability of visible light-shielding and ability of heat insulation are good. In particular, the visible light-shielding film of Ti or Ti nitride is preferred as it is easy to form the film.

Among the above (a), Ti, Nb, Ag, Ni and Cr are more preferred because it is easy to form their film. In particular, Ti is especially preferred.

Among the above (b), Ti nitride (TiN) is more preferred because it is easy to form its film.

Among the above (c), TiAl is more preferred because it is easy to form its film.

Among the above (d), TiAl nitride is more preferred because it is easy to form its film.

Moreover, among (a), (b), (c) and (d), even (a) is more preferred because it is easy to form its film.

Also preferably, the visible light-shielding layer of the glass article of the invention comprises one visible light-shielding film selected from the following (a)-(e) and a heat ray reflection film of the following (f):

(a) one metal selected from the group consisting of Ti, Nb, Ag, Pt, Au, Zr, Hf, Ni and Cr;
(b) one metal nitride with a metal selected from the group consisting of Ti, Nb, Ag, Zr, Hf, Ni and Cr;
(c) one alloy selected from the group consisting of TiAl, NiCr, stainless and hastelloy;
(d) one alloy nitride with an alloy selected from the group consisting of TiAl, NiCr, stainless and hastelloy;
(e) Si;
(f) one oxide selected from the group consisting of tin-doped indium oxide (ITO), fluorine-doped tin oxide, antimony-doped tin oxide, and aluminium-doped zinc oxide.

The glass article of the type is preferred as its ability of visible light-shielding and ability of heat insulation are good.

Among the above (f), ITO is more preferred as its formation is easy and its ability of heat ray reflection is good.

In the above-mentioned visible light-shielding films, (a)-(d) have good ability of visible light-shielding and good ability of heat insulation. Therefore, they may exhibit good ability of heat insulation even in the absence of the additional heat ray reflection film such as (f). They may exhibit better ability of heat insulation when combined with the additional heat reflection film (f) as multi-layered film.

The visible light-shielding film (e) of Si has good ability of visible light-shielding but does not have ability of heat insulation. Therefore, when it is combined with the heat ray reflection film (f) as multi-layered film, then it may additionally have the ability of heat insulation and is favorable.

Preferably, the glass article of the invention has at least a protective film adjacent to the visible light-shielding film or the heat ray reflection film thereof.

Moreover, the protective film preferably comprises at least one selected from the group consisting of SiO₂, Si₃N₄, AlN, SiAlNₓ and TiO₂

In this, the visible light-shielding layer may have additional ability of heat resistance, abrasion resistance and oxidation resistance.

For the protective film, SiO₂ and Si₃N₄ are more preferred as they are excellent in the point of the chemical durability, the film hardness and the dense structure thereof.

The glass article of the invention may have at least an adhesive layer formed therein for preventing delamination of the constitutive layers. Titanium oxide, zirconium oxide, alumina and the like may be used for the adhesive layer. In particular, it is desirable that the adhesive layer is formed between the heat ray reflection film and the protective film since the adhesion between the two is often poor.

Titanium oxide is especially preferred for the adhesive film, because it is easy to form it.

The preferable embodiments of the present invention are indicated below, but the invention is not limited thereto.

The first embodiment of the glass article of the invention comprises the first layer of a visible light-shielding film having 30-500 nm thick and the second layer of a protective film having 50-400 nm thick, on the surface of transparent heat-resistant glass, in this order. The visible light-shielding film in this case may be a film of any of the above-mentioned (a)-(d) and the protective film may be a film of any of SiO₂, Si₃N₄, AlN. SiAlNₓ or TiO₂.

The second embodiment of the glass article of the invention comprises the first layer of a heat ray reflection film having 30-500 nm thick, the second layer of a protective film having 50-400 nm thick and the third layer of a visible light-shielding film having 30-500 nm thick, on the surface of transparent heat-resistant glass, in this order.

The third embodiment of the glass article of the invention comprises the first layer of a heat ray reflection film having 30-500 nm thick, the second layer of a protective film having 50-400 nm thick, the third layer of a visible light-shielding film having 30-500 nm thick and the fourth layer of a protective film having 50-400 nm thick, on the surface of transparent heat-resistant glass, in this order.

The second layer, the protective film in the second and the third embodiments acts to prevent the reaction between the first layer, the heat ray reflection film and the third layer, the visible light-shielding film.

The fourth embodiment of the glass article of the invention comprises the first layer of a heat ray reflection film having 30-500 nm thick, the second layer of an adhesive film having 5-30 nm thick, the third layer of a protective film having 50-400 nm thick, the fourth layer of a visible light-shielding film having 30-500 nm thick and the fifth layer of a protective film having 50-400 nm thick, on the surface of transparent heat-resistant glass, in this order.

The fifth embodiment of the glass article of the invention comprises the first layer of a visible light-shielding film having 30-500 nm thick and the second layer of a protective film having 50-400 nm thick, formed in that order on the surface of transparent heat-resistant glass, and has the first layer of a heat ray reflection film having 30-500 nm thick and the second layer of a protective film having 50-400 nm thick, formed in that order on the opposite surface of the transparent heat-resistant glass.

The heat ray reflection film in the second—the fourth embodiments is the film (f) of any of tin-doped indium oxide, fluorine-doped tin oxide, antimony-doped tin oxide, and aluminium-doped zinc oxide; the protective film is a film of any of SiO₂, Si₃N₄, AlN, SiAlNₓ or TiO₂; and the visible light-shielding film may be a film of any of the above-mentioned (a)-(e).

In the glass article of the invention, the visible light-shielding layer may be formed by sputtering, vapor deposition or ion plating. In particular, sputtering is preferred as it enables to form a dense film which has good abrasion resistance.

When the glass article of the invention is used for observation windows of glass fusing furnaces that are exposed to high temperature and when the observation window comprising it is provided with a metal shutter to cover it, then the glass article is not exposed to heat rays while the observation window is not in service. Therefore, the temperature of the glass article is prevented from being elevated.

Accordingly, the visible light-shielding layer is prevented from deterioration and the glass article is prevented from being deformed and broken by heat, and in addition, heat radiation through the observation window can be retarded and therefore the thermal efficiency of the furnace is hardly lowered. These are the advantages of the glass article of the invention.

When the observation window is further provided with an air-cooling device, in addition to the metal shutter installed thereto, then the temperature of the glass article is more hardly elevated and therefore it is more preferable since the visible light-shielding layer is more effectively prevented from deterioration and the glass article is also more effectively prevented from being deformed and broken by heat.

When the glass article of the invention is used for observation windows of glass fusing furnaces that are exposed to high temperature and when it has a heat ray reflection film formed in such a manner that it is more inside the furnace than the visible light-shielding layer thereof, then the glass article may more effectively reflect heat rays and is therefore favorable since it is hardly heated and hardly transmits heat rays.

When the glass article has the visible light-shielding layer formed on one surface of the transparent heat-resistant glass sheet and when the layer doe not directly face furnaces, then it is favorable since the visible light-shielding layer is not exposed to corrosive gas contained in combustion gas and is therefore hardly deteriorated.

### EXAMPLES

The glass article of the invention is described in detail with reference to the following Examples but the present invention is not limited to these Examples.

Table 1 shows Examples of the invention (Examples 1-6); and Table 2 shows Comparative Examples (Comparative Examples 1 and 2).

TABLE 1

| | | Example 1 | Example 2 | Example 3 | Example 4 | Example 5 | Example 6 |
|---|---|---|---|---|---|---|---|
| Constitution | 5th layer | — | — | — | Si₃N₄ (100) | — | — |
| | (thickness, (nm)) | | | | | | |
| | 4th layer | — | Si₃N₄ (150) | Si₃N₄ (100) | Ti (67) | — | — |
| | (thickness, (nm)) | | | | | | |
| | 3rd layer | — | Ti (87) | Ti (67) | SiO₂ (100) | Si (100) | — |
| | (thickness, (nm)) | | | | | | |
| | 2nd layer | Si₃N₄ (150) | SiO₂ (100) | SiO₂ (100) | TiO₂ (10) | SiO₂ (100) | Si₃N₄ (150) |
| | (thickness, (nm)) | | | | | | |
| | 1st layer | Ti (87) | ITO (450) | ITO (450) | ITO (450) | ITO (450) | Ti (87) |
| | (thickness, (nm)) | | | | | | |
| | Glass | transparent | transparent | transparent | transparent | transparent | transparent |
| | | crystallized | crystallized | crystallized | crystallized | crystallized | crystallized |
| | | glass | glass | glass | glass | glass | glass |
| | 1st layer | — | — | — | — | — | ITO (450) |
| | (thickness, (nm)) | | | | | | |
| | 2nd layer | — | — | — | — | — | SiO₂ (100) |
| | (thickness, (nm)) | | | | | | |

| | | | | | | |
|---|---|---|---|---|---|---|
| average visible light transmittance | 0.3 | 0.3 | 3.4 | 3.4 | 0.05 | 0.2 |
| (%) | | | | | | |
| average reflectance at a | 55 | 72 | 72 | 72 | 73 | 76 |
| wavelength of 1000-2500 nm (%) | | | | | | |
| average transmittance at a | 4.5 | 0.1 | 0.1 | 0.1 | 0.5 | 0.1 |
| wavelength of 1000-2500 nm (%) | | | | | | |
| ability of visible light-shielding | ◯ | ◯ | ◯ | ◯ | ◯ | ◯ |
| visibility | ◯ | ◯ | ◯ | ◯ | ◯ | ◯ |
| heat insulation | ◯ | ◯ | ◯ | ◯ | ◯ | ◯ |
| heat resistance | ◯ | ◯ | ◯ | ◯ | ◯ | ◯ |
| outward appearance | gold | gold | bluish silver | bluish silver | silver | gold |

TABLE 2

| | Comparative | Comparative |
|---|---|---|
| | Example 1 | Example 2 |
| Glass | color glass | transparent |
| | | crystallized glass |
| average visible light | 1.8 | 89 |
| transmittance (%) | | |
| average reflectance at a | 4 | 7 |
| wavelength of 1000- | | |
| 2500 nm (%) | | |
| average transmittance at | 0.8 | 87 |
| a wavelength of 1000- | | |
| 2500 nm (%) | | |
| ability of visible | ∘ | x |
| light-shielding | | |
| Visibility | ∘ | x |
| heat insulation | — | x |
| heat resistance | x | ∘ |

### Examples 1 to 6

In Examples 1-6, films were formed on a transparent crystallized glass having 5 mm thick (N-0: manufactured by Nippon Electric Glass Co., Ltd), by sputtering to form glass articles. The order of the film formation and the thickness of each film formed are as in Table 1. The transparent crystallized glass used is LiO₂—Al₂O₃—SiO₂ crystallized glass that comprises β-quartz solid solution as the main crystal thereof, and its average thermal expansion coefficient at 30-380° C. was −5×10⁻⁷/° C.

### Comparative Example 1

In Comparative Example 1, an eye protector lens having a scale number of 5 as determined according to JIS T-8141 (SOLIDA#5: manufactured by Riken Optic) was used. This is formed of color glass and has 2.2 mm thick.

### Comparative Example 2

In Comparative Example 2, no films were formed on the transparent crystallized glass (N-0: manufactured by Nippon Electric Glass Co., Ltd) used in Examples.

The average visible light transmittance was determined in accordance with JIS R-3106.

The average reflectance at a wavelength of 1000-2500 nm and the average transmittance at a wavelength of 1000-2500 nm were determined at regular intervals of 2 nm by the use of a spectrophotometer (UV3100PC: manufactured by Shimadzu Corporation), and the data were averaged. The visible light transmittance, the reflectance and the transmittance were measured on the side of the glass surface in Examples 1-5, and on the SiO₂ film side in Example 6.

The ability of visible light-shielding was evaluated as follows: The glass article having a size of 150×150 cm was installed into an observation window frame formed of calcium silicate plate in an electric furnace, and the electric furnace was heated at 1000° C.

In that condition, the inside of the electric furnace was observed with the naked eye through the glass article of the window, at a site spaced from the glass article by 25 cm. When the operator was not dazzled, then the sample is good “◯”; but when the operator was dazzled, then the sample is not good “x”.

The visibility was evaluated as follows. The glass article was set in the same manner as in the ability of visible light-shielding test as above, and the inside of the electric furnace was observed with the naked eye through the glass article of the window, at a site spaced from the glass article by 25 cm. When the operator could readily confirm the inside of the furnace, then the sample is good “◯”; but when the operator could not readily confirm it, then the sample is not good “x”.

The heat insulation was evaluated as follows. The glass article was set in the same manner as in the ability of visible light-shielding test as above, and the inside of the electric furnace was observed with the naked eye through the glass article of the window, at a site spaced from the glass article by 25 cm. When the operator did not feel hot, then the sample is good “◯”; but when the operator felt hot, then the sample is not good “x”.

In these tests, the samples of Examples 1-5 were set that their glass surface could face inside the furnace. And the sample of Example 6 was set that its SiO₂ film side could face inside the furnace. However, the method did not apply to Comparative Example 1, in which the inside of the electric furnace heated at 1000° C. was directly observed via the eye protector (SOLIDA#5).

The heat resistance was evaluated as follows. The glass article having a size of 40×20 mm was kept in an electric furnace previously heated at 250° C., for 1 week. When the sample was neither broken nor delaminated, then it is good “◯”; but when the sample was broken or delaminated, then it is not good “x”.

The outward appearance was evaluated by observing the samples with the naked eye.

As it is apparent from Table 1, the samples of Examples 1-6 are all good in the point of the ability of visible light-shielding, the visibility, the heat insulation and the heat resistance.

As opposed to these, the sample of Comparative Example 1 is good in the point of the ability of visible light-shielding but is not good in the point of the heat resistance since it was broken immediately after put into the electric furnace; and the sample of Comparative Example 2 had neither ability of visible light-shielding nor ability of heat insulation, as in Table 2.

### INDUSTRIAL APPLICABILITY

As in the above, the glass article of the invention has a visible light-shielding layer formed on transparent heat-resistant glass, and the layer has the ability of visible light-shielding and the ability of heat ray reflection. Therefore, the glass article prevents visible light and heat ray transmission through it, and is favorable for observation windows of garbage incinerators, cremation furnaces, metal fusing furnaces, glass fusing furnaces, heat treating furnaces and other furnaces that are exposed to high temperature.

While the invention has been described in detail and with reference to specific embodiments thereof, it will be apparent to one skilled in the art that various changes and modifications can be made therein without departing from the spirit and scope thereof.

This application is based on Japanese patent application No.2003-331037 filed on Sep. 24, 2003, and No 2004-233820 filed on Aug. 10, 2004 the entire content of which is incorporated herein by reference.

1. A glass article which comprises a transparent heat-resistant glass sheet and a visible light-shielding layer on the surface thereof,
wherein an average visible light transmittance of the glass article at a wavelength of 380-780 nm is 0.03-15%; and
an average infrared reflectance of the glass article at a wavelength of 1000-2500 nm is at least 50%.

2. The glass article according to claim 1, wherein an average infrared transmittance of the glass article at a wavelength of 1000-2500 nm is 10% or less.

3. The glass article according to claim 1, wherein an average thermal expansion coefficient at 30-380° C. of the transparent heat-resistant glass sheet is −20-+50×10⁻⁷/° C.

4. The glass article according to claim 3, wherein the transparent heat-resistant glass sheet is any of transparent crystallized glass, high silicate glass, borosilicate glass or quartz glass.

5. The glass article according to claim 1, wherein the visible light-shielding layer comprises a visible light-shielding film and optionally a heat ray reflection film.

6. The glass article according to claim 1, wherein the visible light-shielding layer comprises a visible light-shielding film selected from the following (a) to (d)
(a) one metal selected from the group consisting of Ti, Nb, Ag, Pt, Au, Zr, Hf, Ni and Cr;
(b) one metal nitride with a metal selected from the group consisting of Ti, Nb, Ag, Zr, Hf, Ni and Cr;
(c) one alloy selected from the group consisting of TiAl, NiCr, stainless and hastelloy;
(d) one alloy nitride with an alloy selected from the group consisting of TiAl, NiCr, stainless and hastelloy.

7. The glass article according to claim 1, wherein the visible light-shielding layer comprises a visible light-shielding film selected from the following (a) to (e) and a heat ray reflection film of the following (f):
(a) one metal selected from the group consisting of Ti, Nb, Ag, Pt, Au, Zr, Hf, Ni and Cr;
(b) one metal nitride with a metal selected from the group consisting of Ti, Nb, Ag, Zr, Hf, Ni and Cr;
(c) one alloy selected from the group consisting of TiAl, NiCr, stainless and hastelloy;
(d) one alloy nitride with an alloy selected from the group consisting of TiAl, NiCr, stainless and hastelloy;
(e) Si;
(f) one oxide selected from the group consisting of tin-doped indium oxide, fluorine-doped tin oxide, antimony-doped tin oxide, and aluminium-doped zinc oxide.

8. The glass article according to claim 5, which has at least a protective film adjacent to the visible light-shielding film or the heat ray reflection film thereof.

9. The glass article according to claim 8, wherein the protective film comprises at least one selected from the group consisting of SiO₂, Si₃N₄, AlN, SiAlNₓ and TiO₂.

10. The glass article according to claim 1, which has at least an adhesive layer.

11. The glass article according to claim 8, wherein the heat-resistant glass sheet comprises, on the surface thereof, the visible light-shielding film and the protective film, in this order.

12. The glass article according to claim 8, wherein the heat-resistant glass sheet comprises, on the surface thereof, the heat ray reflection film, the protective film, and the visible light-shielding film, in this order.

13. The glass article according to claim 8, wherein the heat-resistant glass sheet comprises, on the surface thereof, the heat ray reflection film, the protective film, the visible light-shielding film, and the protective film, in this order.

14. The glass article according to claim 8, wherein the heat-resistant glass sheet comprises, on the surface thereof, the heat ray reflection film, the adhesive film, the protective film, the visible light-shielding film, and the protective film, in this order.

15. The glass article according to claim 8, wherein the heat-resistant glass sheet comprises, on the surface thereof, the visible light-shielding film and the protective film, in this order; and on the opposite surface thereof, the heat ray reflection film and the protective film, in this order.
